(19) United States
(12) Patent Application Publication
(10) Pub. No.: US 2024/0060653 A1
(43) Pub. Date: Feb. 22, 2024

(54) COOKTOP

(71) Applicant: LG ELECTRONICS INC., Seoul (KR)

(72) Inventors: Seungbok OK, Seoul (KR); Dooyong OH, Seoul (KR); Hojae SEONG, Seoul (KR); Byeongwook PARK, Seoul (KR)

(73) Assignee: LG ELECTRONICS INC., Seoul (KR)

(21) Appl. No.: 18/270,337

(22) PCT Filed: Jan. 29, 2021
(86) PCT No.: PCT/KR2021/001258

§ 371 Date: Jun. 29, 2023

(30) Foreign Application Priority Data
Dec. 30, 2020 (KR) 10-2020-0187883

(51) Int. Cl. F24C 15/10; F24C 7/08; H05B 6/12

(52) U.S. Cl. CPC F24C 15/102; F24C 7/087; H05B 6/1209; H05B 2213/07

(57) ABSTRACT

A cooktop can include a top plate glass configured to support placement of a cooking container; a memory configured to store a plurality of regression models indicating a relationship between a temperature of the top plate glass and a cooking temperature of the cooking container; a temperature sensor configured to sense the temperature of the top plate glass when operating in a heating mode and output a sensing value; and a processor. Also, the processor can be configured to select a regression model from among the plurality of regression models based on the sensing value of the temperature sensor, and calculate the cooking temperature of the cooking container based on the regression model.

### CROSS-REFERENCE TO RELATED APPLICATION

This application is the National Phase of PCT International Application No. PCT/KR2021/001258, filed on Jan. 29, 2021, which claims priority under 35 U.S.C. § 119(a) to Patent Application No. 10-2020-0187883, filed in the Republic of Korea on Dec. 30, 2020, all of which are hereby expressly incorporated by reference into the present application.

### BACKGROUND

### Technical Field

The present disclosure relates to a cooktop.

### Discussion of Related Art

Various types of cooking appliances are used to heat food at home or in a restaurant. According to the related art, a gas stove using gas as a fuel source has been widely used. However, recently, devices for heating an object to be heated, for example, a cooking container such as a pot, have been using electricity instead of gas.

A method for heating the object to be heated using electricity is largely divided into a resistance heating method and an induction heating method. The electrical resistance method is a method for heating an object by transferring heat generated when electric current flows through a metal resistance wire or a non-metal heating body, such as silicon carbide to the object to be heated (e.g., a cooking container), through radiation or conduction. In the induction heating method, when high-frequency power having a predetermined intensity is applied to a coil, eddy currents are generated in the object to be heated using magnetic fields generated around the coil so that the object is heated.

In the present disclosure, a cooktop can include resistance heating type cooking equipment, induction heating type cooking equipment, and a combination of resistance heating type and induction heating type cooking equipment.

Such a cooktop can provide various user-friendly functions by predicting a cooking temperature. Here, the cooking temperature can refer to a temperature of food in a cooking container being heated by the cooktop. For this type of feature, the cooktop according to the related art indirectly measures the cooking temperature by sensing a temperature of a top plate glass on which the cooking container is placed with a temperature sensor. However, since the temperature of the cooking container is indirectly measured as described above, measurement errors of the cooking temperature frequently occur depending on a material or thickness of the container.

### SUMMARY OF THE DISCLOSURE

An object of the present disclosure is to provide a cooktop that more accurately predicts a cooking temperature.

An object of the present disclosure is to provide a cooktop that predicts a cooking temperature in consideration of a material and/or thickness of a cooking container and an amount of food in the cooking container.

An object of the present disclosure is to provide a cooktop that notifies a user that the cooktop is reaching to a target temperature and informs the user about how much time is remaining until the cooktop reaches the target temperature.

### Technical Solution

A cooktop according to an embodiment of the present disclosure calculates a cooking temperature using a plurality of pre-constructed regression models.

A cooktop according to an embodiment of the present disclosure calculates a cooking temperature using a regression model derived from big data analysis obtained under various conditions, such as a material of a cooking container, an amount of food in the cooking container, and a temperature of a top plate glass.

A cooktop according to an embodiment of the present disclosure provides a cooktop that informs a user about how much time is remaining until the cooktop reaches a target temperature according to a current cooking temperature through a regression model.

### Advantageous Effects

According to an embodiment of the present disclosure, the cooktop can accurately predict the heat transfer pattern of the cooking container currently being heated through the pre-constructed regression model, thereby improving the prediction accuracy of the cooking temperature and the amount of time remaining.

In addition, since the cooktop uses the regression model constructed based on the material and/or thickness of the cooking container as well as the amount of water or food in the cooking container, the cooking temperature prediction model can be adaptively and dynamically changed to suit the various cooking situations, thereby improving the prediction accuracy for the cooking temperature and the amount of time remaining.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a perspective view illustrating a cooktop and a cooking container according to an embodiment of the present disclosure.

FIG. 2 is a cross-sectional view illustrating the cooktop and the cooking container according to an embodiment of the present disclosure.

FIG. 3 is a circuit diagram of the cooktop according to an embodiment of the present disclosure.

FIG. 4 is a view illustrating output characteristics of the cooktop according to an embodiment of the present disclosure.

FIG. 5 is a control block diagram of the cooktop according to an embodiment of the present disclosure.

FIG. 6 is a flowchart illustrating an operating method of the cooktop according to an embodiment of the present disclosure.

FIG. 7 is a view illustrating an example of process in which the cooktop selects a regression model through an average and a variance of slopes according to an embodiment of the present disclosure.

FIG. 8, including parts (a) and (b), illustrates examples of a display of the cooktop according to an embodiment of the present disclosure.

### DETAILED DESCRIPTION OF THE EMBODIMENTS

Hereinafter, embodiments relating to the present disclosure will be described in detail with reference to the accompanying drawings. Furthermore, terms, such as a “module” and a “unit,” are used for convenience of description, and they do not have different meanings or functions in themselves.

Hereinafter, an induction heating type cooktop and an operation method thereof according to an embodiment of the present disclosure will be described. For convenience of description, the “induction heating type cooktop” is referred to as a “cooktop.” The following embodiments can be partially or entirely bonded to or combined with each other and can be linked and operated in technically various ways. The embodiments can be carried out independently of or in association with each other.

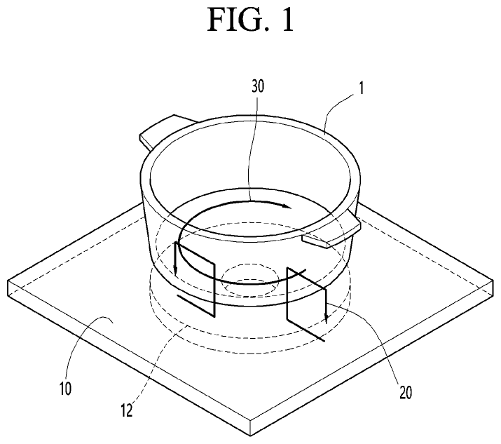

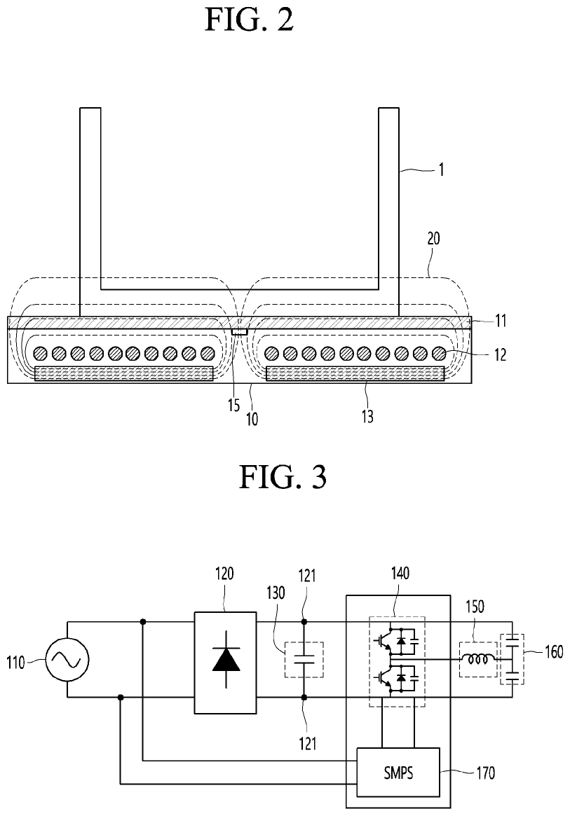

FIG. 1 is a perspective view illustrating a cooktop and a cooking container according to an embodiment of the present disclosure, and FIG. 2 is a cross-sectional view illustrating the cooktop and the cooking container according to an embodiment of the present disclosure.

A cooking container 1 can be disposed above or on the cooktop 10, and the cooktop 10 can heat the cooking container 1 disposed thereon.

First, a method for heating the cooking container 1 using the cooktop 10 will be described.

As illustrated in FIG. 1, the cooktop 10 can generate a magnetic field 20 so that at least a portion of the magnetic field 20 passes through the cooking container 1. Here, if an electrical resistance component is contained in a material of the cooking container 1, the magnetic field 20 can induce an eddy current 30 in the cooking container 1. Since the eddy current 30 generates heat in the cooking container 1 itself, and the heat is conducted or radiated up to the inside of the cooking container 1, contents of the cooking container 1 can be cooked.

When the material of the cooking container 1 does not contain the electrical resistance component, the eddy current 30 does not occur. Thus, in this situation, the cooktop 10 may not heat the cooking container 1.

As a result, the cooking container 1 capable of being heated by the cooktop 10 can be a stainless steel container or a metal container such as an enamel or cast iron container.

Next, a method for generating the magnetic field 20 by the cooktop 10 will be described.

As illustrated in FIG. 2, the cooktop 10 can include at least one of a top plate glass 11, a working coil 12, ferrite 13, or a temperature sensor 15.

The top plate glass 11 can support the cooking container 1. That is, the cooking container 1 can be placed on a top surface of the top plate glass 11.

In addition, the top plate glass 11 can be made of ceramic tempered glass obtained by synthesizing various mineral materials. Thus, the top plate glass 11 can protect the cooktop 10 from an external impact.

In addition, the top plate glass 11 can prevent foreign substances such as dust or liquids from being introduced into the cooktop 10.

The working coil 12 can be disposed below the top plate glass 11. Current can be supplied to the working coil 12 to generate the magnetic field 20. Specifically, the current can flow through the working coil 12 according to on/off operation of an internal switching element of the cooktop 10.

When the current flows through the working coil 12, the magnetic field 20 can be generated, and the magnetic field 20 can generate the eddy current 30 by meeting the electrical resistance component contained in the cooking container 1. The eddy current can heat the cooking container 1, and thus, the contents of the cooking container 1 can be cooked.

In addition, heating power of the cooktop 10 can be selectively adjusted according to an amount of current flowing through the working coil 12. As a specific example, as the current flowing through the working coil 12 increases, the magnetic field 20 can become stronger, and thus, since the magnetic field passing through the cooking container 1 increases, the heating power of the cooktop 10 can increase.

The ferrite 13 is a component for protecting an internal circuit of the cooktop 10. Specifically, the ferrite 13 serves as a shield to block an influence of the magnetic field 20 generated from the working coil 12 or an electromagnetic field generated from the outside on the internal circuit of the cooktop 10.

For this, the ferrite 13 can be made of a material having very high magnetic permeability. The ferrite 13 serves to induce the magnetic field introduced into the cooktop 10 to flow through the ferrite 13 without being radiated through to the other side of the ferrite 13. The movement of the magnetic field 20 generated in the working coil 12 by the ferrite 13 can be as illustrated in FIG. 2.

The temperature sensor 15 can be disposed on a bottom surface of the top plate glass 11. The temperature sensor 15 can sense a temperature of the top plate glass 11. The cooktop 10 can further include components in addition to the top plate glass 11, the working coil 12, the ferrite 13, and the temperature sensor 15, which are described above. For example, the cooktop 10 can further include an insulator disposed between the top plate glass 11 and the working coil 12. That is, the cooktop according to the present disclosure is not limited to the cooktop 10 illustrated in FIG. 2.

FIG. 3 is a circuit diagram of the cooktop according to an embodiment of the present disclosure.

Since the circuit diagram of the cooktop 10 illustrated in FIG. 3 is merely illustrative for convenience of description, the embodiment of the present disclosure is not limited thereto.

Referring to FIG. 3, the induction heating type cooktop can include at least some or all of a power supply 110 (e.g., an AC power source), a rectifier 120, a DC link capacitor 130, an inverter 140, a working coil 150, a resonance capacitor 160, and a switching mode power supply (SMPS) 170.

The power supply 110 can receive external power. Power received from the outside to the power supply 110 can be alternating current (AC) power.

The power supply 110 can supply an AC voltage to the rectifier 120.

The rectifier 120 is an electrical device for converting alternating current into direct current. The rectifier 120 converts the AC voltage supplied through the power supply 110 into a DC voltage. The rectifier 120 can supply the converted voltage to both DC ends 121 of the DC link capacitor 130.

An output terminal of the rectifier 120 can be connected to both of the DC ends 121 of the DC link capacitor 130. Each of the ends 121 of the DC output through the rectifier 120 can be referred to as a DC link. A voltage measured at each of the DC ends 121 is referred to as a DC link voltage.

A DC link capacitor 130 serves as a buffer between the power supply 110 and the inverter 140. Specifically, the DC link capacitor 130 is used to maintain the DC link voltage converted through the rectifier 120 to supply the DC link voltage to the inverter 140.

The inverter 140 serves to switch the voltage applied to the working coil 150 so that high-frequency current flows through the working coil 150. The inverter 140 drives the switching element, which can include insulated gate bipolar transistors (IGBTs) to allow high-frequency current to flow through the working coil 150, and thus, a high-frequency magnetic field is generated in the working coil 150.

In the working coil 150, current may or may not flow depending on whether the switching element is driven. When current flows through the working coil 150, magnetic fields are generated. The working coil 150 can heat a cooking appliance by generating the magnetic fields as the current flows.

One side of the working coil 150 is connected to a connection point of the switching element of the inverter 140, and the other side of the working coil 150 is connected to the resonance capacitor 160.

The switching element is driven by a driver, and a high-frequency voltage is applied to the working coil 150 while the switching element operates alternately by controlling a switching time output from the driver. In addition, since a turn on/off time of the switching element applied from the driver is controlled in a manner that is gradually compensated, the voltage supplied to the working coil 150 is converted from a low voltage into a high voltage.

The resonance capacitor 160 can be a component to serve as a buffer. The resonance capacitor 160 controls a saturation voltage increasing rate during the turn-off of the switching element to affect an energy loss during the turn-off time.

The SMPS 170 (switching mode power supply) refers to a power supply that efficiently converts power according to a switching operation. The SMPS 170 converts a DC input voltage into a voltage that is in the form of a square wave and then obtains a controlled DC output voltage through a filter. The SMPS 170 can minimize unnecessary loss by controlling a flow of the power using a switching processor.

In the cooktop 10 expressed by the circuit diagram illustrated in FIG. 3, a resonance frequency is determined by an inductance value of the working coil 150 and a capacitance value of the resonance capacitor 160. Then, a resonance curve can be formed around the determined resonance frequency, and the resonance curve can represent output power of the cooktop 10 according to a frequency band.

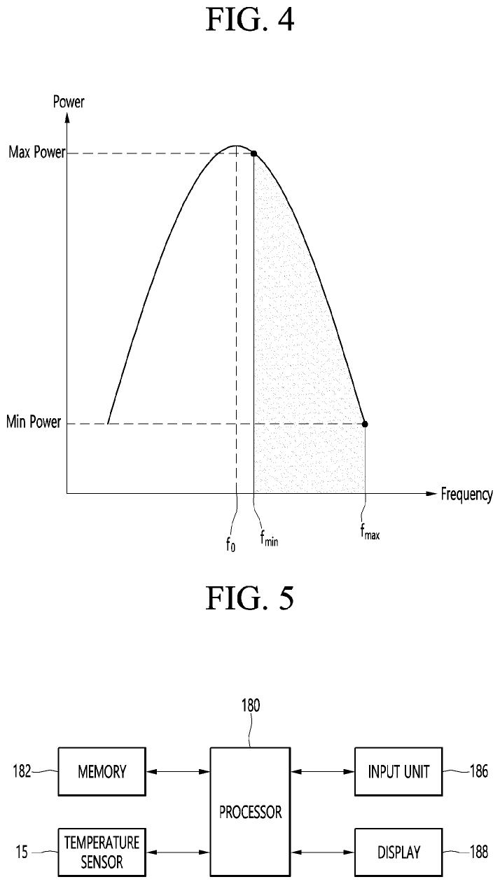

Next, FIG. 4 is a view illustrating output characteristics of the cooktop according to an embodiment of the present disclosure.

First, a Q factor (quality factor) can be a value representing sharpness of resonance in the resonance circuit. Therefore, in the cooktop 10, the Q factor is determined by the inductance value of the working coil 150 included in the cooktop 10 and the capacitance value of the resonant capacitor 160. The resonance curve can be different depending on the Q factor. Thus, the cooktop 10 has different output characteristics according to the inductance value of the working coil 150 and the capacitance value of the resonant capacitor 160.

FIG. 4 illustrates an example of the resonance curve according to the Q factor. In general, the larger the Q factor, the sharper the shape of the curve, and the smaller the Q factor, the broader the shape of the curve.

A horizontal axis of the resonance curve can represent a frequency, and a vertical axis can represent output power. A frequency at which maximum power is output in the resonance curve is referred to as a resonance frequency f0.

In general, the cooktop 10 uses a frequency in a right region based on the resonance frequency f0 of the resonance curve (e.g., a point to the right of f0). In addition, the cooktop 1 can have a minimum operating frequency and a maximum operating frequency, which are set in advance.

For example, the cooktop 10 can operate at a frequency corresponding to a range from the minimum operating frequency fₘᵢₙ to the maximum operating frequency fₘₐₓ. That is, the operating frequency range of the cooktop 10 can be from the minimum operating frequency fₘᵢₙ to the maximum operating frequency fₘₐₓ.

For example, the maximum operating frequency fₘₐₓ can be an IGBT maximum switching frequency. The IGBT maximum switching frequency can mean a maximum driving frequency determined in consideration of a resistance voltage and capacity of the IGBT switching element. For example, the maximum operating frequency fₘₐₓ can be 75 kHz.

The minimum operating frequency fₘᵢₙ can be about 20 kHz. In this situation, since the cooktop 10 does not operate at an audible frequency (about 16 Hz to 20 kHz), noise of the cooktop 10 can be reduced.

Since setting values of the above-described minimum operating frequency fₘᵢₙ and maximum operating frequency fₘₐₓ are only examples, the embodiment of the present disclosure is not limited thereto.

When receiving a heating command, the cooktop 10 can determine an operating frequency according to a heating power level set by the heating command. Specifically, the cooktop 10 can dynamically adjust the output power by decreasing the operating frequency as the heating power level is set higher, and by increasing the operating frequency as the heating power level is set lower. That is, when receiving the heating command, the cooktop 10 can perform a heating mode in which the cooktop operates in one of the operating frequency ranges according to the set heating power.

The cooktop 10 can predict the cooking temperature while operating in the heating mode. Here, the cooking temperature can refer to a temperature of food or liquid in a cooking container being heated by the cooktop.

The cooktop 10 can recognize the temperature of the top plate glass 11 sensed by the temperature sensor 15 as the cooking temperature, but in this situation, the cooking temperature can be indirectly predicted through the temperature of the top plate glass 11, which can impair accuracy.

Thus, the cooktop 10 according to an embodiment of the present disclosure can more accurately predict the cooking temperature by applying the temperature of the top plate glass 11 to pre-constructed cooking temperature prediction data.

Hereinafter, a method of predicting the cooking temperature using the cooking temperature prediction data pre-constructed by the cooktop 10 according to an embodiment of the present disclosure will be described in detail.

FIG. 5 is a control block diagram of the cooktop according to an embodiment of the present disclosure.

The cooktop 10 according to an embodiment of the present disclosure can include at least one or more of a processor 180, a memory 182, a temperature sensor 15, an input unit 186 (e.g., an input interface, buttons, a touchscreen, etc.), and a display 188.

The processor 180 can control an operation of the cooktop 10. The processor 180 can control each of the memory 182, the temperature sensor 15, the input unit 186, and the display 188. In addition, the processor 180 can control the components illustrated in FIG. 3. That is, the processor 180 can control each of the power supply 110, the rectifier 120, the DC link capacitor 130, the inverter 140, the working coil 150, the resonance capacitor 160, and the SMPS 170.

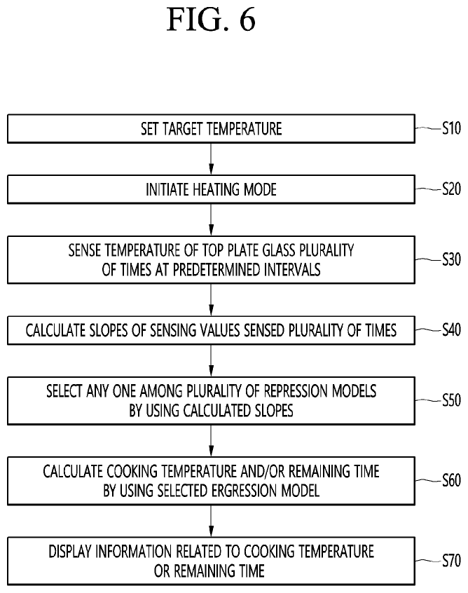

In addition, the processor 180 can select one of a plurality of regression models based on a sensed value of the temperature sensor 15 and calculate the cooking temperature based on the selected regression model. This will be described in detail in FIG. 6 and the like.

The memory 182 can store cooking temperature prediction data. The cooking temperature prediction data can be data measured and analyzed through experiments before or during the manufacture of the cooktop 10. For example, the cooking temperature prediction data can include a plurality of regression models representing a relationship between the temperature of the top plate glass 11 and the cooking temperature.

That is, according to an embodiment of the present disclosure, the memory 182 can store a plurality of regression models representing a relationship between the temperature of the top plate glass 11 and the cooking temperature. Here, the temperature of the top plate glass 11 can be a temperature sensed through the temperature sensor 15.

The plurality of regression models can be derived by cooking temperature values measured while changing different factors, such as the type of cooking container 1, an amount of water in the cooking container 1, a type of food or material in the cooking container, a weight of the cooking container 1 and a weight its contents such as food or liquid, and an initial temperature of the top plate glass 11. Each of the plurality of regression models can be derived in the form of a function. Here, the initial temperature of the top plate glass 11 can indicate residual heat of the top plate glass 11.

Specifically, the initial temperature of the top plate glass 11 can be variously set within a range of about 25 degrees to 80 degrees, the water or food can be variously contained within a range of about 500 cc to 1500 cc, and the temperature of the top plate glass 11 sensed by the temperature sensor 15 and an actual cooking temperature measured through a thermometer can be obtained while heating each of the various cooking containers 1, which are distinguished by material, shape, and size. At least one discriminant can be determined from the temperature of the top plate glass 11 obtained in this way and the actual cooking temperature through clustering analysis, and the discriminant thus determined can be derived as a regression model through regression analysis. For example, the regression model has the form of Equation 1 below, and a coefficient w1 or a constant b1 can be different.

Y_{WT}=W₁*X_{TH}+b₁ [Equation 1]

In Equation 1 above, Y_{WT} can indicate a cooking temperature, and X_{TH} can mean a sensing value of the temperature sensor 15.

That is, a plurality of regression models obtained through the above-described experiments can be stored in the memory 182 of the cooktop 10. The plurality of regression models can be updated by receiving a feedback input or the like.

The temperature sensor 15 can sense a temperature of the top plate glass 11.

The input unit 186 can receive a user input. For example, the input unit 186 can receive a heating command, a heating power level setting command, and the like. In addition, the input unit 186 can receive a target temperature setting command. Here, the target temperature can be a temperature that the user wishes the food to reach by heating. According to embodiments, the target temperature can be set as a default.

The display 188 can display various information related to the operating state of the cooktop 10. For example, the display 188 can display a current cooking temperature, a set target temperature, a remaining time until food reaches the set target temperature, and the like.

Next, referring to FIG. 6, an operating method of the cooktop according to an embodiment of the present disclosure will be described. FIG. 6 is a flowchart illustrating an operating method of the cooktop according to an embodiment of the present disclosure.

The processor 180 can set a target temperature (S10).

The processor 180 can set the target temperature according to a target temperature value received from a user through an input unit 186 (e.g., via a touchscreen or one or more buttons), set a target temperature according to a target temperature value set as a default, or set a target temperature according to a heating power level.

The target temperature value set as the default can be about 90 to 95 degrees, but since this is merely an example, it is reasonable not to be limited thereto. In addition, the target temperature value can be preset differently depending on the heating power level.

The processor 180 can initiate a heating mode (S20).

The processor 180 can initiate a heating mode so that a cooking container 1 is heated. The processor 180 can control an inverter 140 or the like to heat the cooking container 1 in the heating mode.

After initiating the heating mode, the processor 180 can sense a temperature of a top plate glass 11 a plurality of times at predetermined intervals (S30) (e.g., polling the temperature every 1 second or every 5 seconds, etc.).

The temperature sensor 15 can sense the temperature of the top plate glass 11 when operating in the heating mode.

According to an embodiment, a process of determining whether the operating time in the heating mode has passed a predetermined preparation time after initiating the heating mode can be added. That is, the processor 180 can sense the temperature of the top plate glass 11 when the preparation time elapses after initiating the heating mode.

Specifically, when the heating mode is initiated, the processor 180 can drive a timer to count a time until a preparation time (e.g., about 5 seconds) elapses, and thus, it is determined whether the operating time in the heating mode elapses the preparation time. As a result, the cooktop 10 can minimize an error in which a regression model is not properly selected due to residual heat of the top plate glass 11, residual heat of the cooking container 1, and the like. That is, in the cooktop 10 according to the embodiment of the present disclosure, there is an advantage in that an influence of the residual heat of the top plate glass 11 or the residual heat of the cooking container 1 on the selection of the regression model can be minimized by using the sensing value that is measured after the preparation time has elapsed during the operation time in the heating mode.

However, according to an embodiment, as illustrated in FIG. 6, the processor 180 can sense the temperature of the top plate glass 11 a plurality of times at predetermined intervals immediately after initiating the heating mode (e.g., every 1 second or every 5 seconds, etc.).

Specifically, when the heating mode is initiated, the processor 180 can control the temperature sensor 15 to sense the temperature of the top plate glass 11 a plurality of times at predetermined intervals for a predetermined measurement time. Here, the measurement time can be about 60 seconds to about 120 seconds, and the predetermined interval can be about 10 seconds, but since this is merely an example, it is not limited thereto. Hereinafter, for convenience of description, it is assumed that the processor 180 controls the temperature sensor 15 when the operating time in the heating mode is 10 seconds, 20 seconds, 30 seconds, 40 seconds, 50 seconds, and 60 seconds to sense the temperature of the upper plate glass 11 six times in total.

When the processor 180 senses the temperature of the top plate glass 11 a plurality of times, it can calculate slopes of the sensed values that are sensed a plurality of times (S40).

For example, the processor 180 can calculate a slope between a value sensed when the operating time in the heating mode is 10 seconds and a value sensed when the operating time in the heating mode is 20 seconds, a slope between a value sensed when the operating time in heating mode is 20 seconds and a value sensed when the operating time in heating mode is 30 seconds, . . . , a slope between a value sensed when the operation time in heating mode is 50 seconds and a value sensed when the operation time in heating mode is 60 seconds. In this way, the processor 180 can more accurately predict a heating curve of the container 1 and its contents.

When the processor 180 calculates slopes of the sensed values sensed a plurality of times, it can select one of a plurality of regression models using the calculated slopes (S50).

According to an embodiment, the processor 180 can select one of the plurality of regression models based on at least one of a mean or variance of slopes.

Specifically, the processor 180 can calculate the average and variance of the calculated slopes. The processor 180 can calculate a cooking temperature prediction function through the mean and variance of the calculated slopes. The processor 180 can select one of the plurality of regression models stored in the memory 182 based on the calculated cooking temperature prediction function. That is, the processor 180 can automatically select one regression model that is most similar to the cooking temperature prediction function among the plurality of regression models stored in the memory 182.

Here, the processor 180 can select one of linear regression models from the plurality of regression models when the variance is less than the preset reference value, and select one of nonlinear regression models among the plurality of regression models when the variance is greater than the preset reference value. This is done because the cooking temperature is highly likely to change nonlinearly when there is a lot of residual heat in the top plate glass 11 or when the thickness of the cooking container 1 is very thin (e.g., in these types of situations, the temperature can quickly accelerate). This situation can be predicted with variance to be controlled so that the nonlinear regression model is selected, thereby minimizing a possibility of any errors. That is, the processor 180 can accurately calculate the cooking temperature using the linear regression model when the variance is less than a predetermined reference value and accurately calculate the cooking temperature using the nonlinear regression model when the variance is greater than the reference value. Here, the reference value can be set differently according to the specifications of the cooktop 1, the distribution of the plurality of regression models, and the like. The nonlinear regression model can be expressed as a combination of different functions (e.g., functions having different coefficients and constants in Equation 1 above) for each section, but this is only an example.

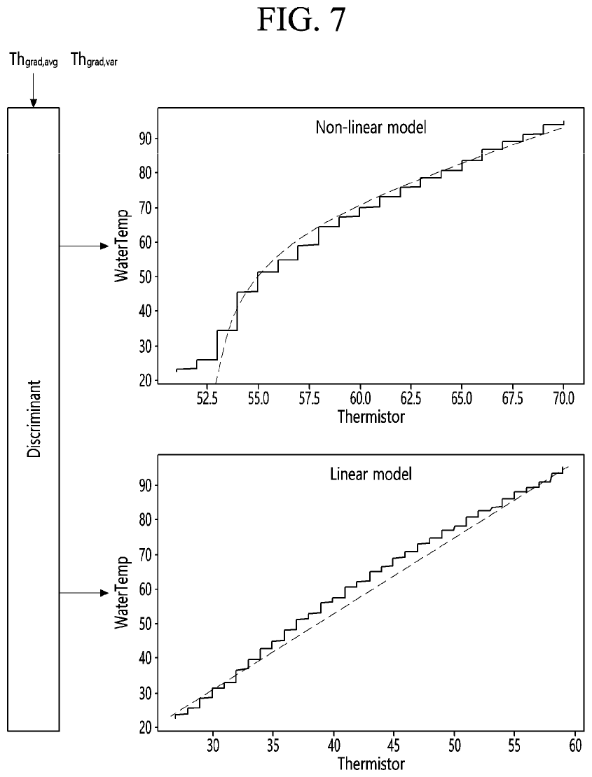

FIG. 7 is a view illustrating an example of process in which the cooktop selects a regression model through an average and a variance of slopes according to an embodiment of the present disclosure.

As illustrated in FIG. 7, the processor 180 can substitute the average of the slopes (TH_{grad,avg}) and the variance of the slopes (TH_{grad,var}) into a discriminant, and one of the regression models expressed as the nonlinear regression model or the linear regression model can be selected. Here, the discriminant can be an equation for calculating the cooking temperature prediction function using the average and variance of the slopes and then comparing the cooking temperature prediction function with the plurality of regression models stored in the memory 182, but this is merely an example. That is, the discriminant can be an arbitrary equation calculated so that any one of the plurality of regression models stored in the memory 182 is selected using the average and variance of the slopes in addition to the above-described method.

According to an embodiment, the processor 180 can determine that the cooking temperature is not calculated when the variance of the slopes is greater than or equal to a predetermined threshold value. This is to minimize user inconvenience when there is a high chance of error, since the fact that the variance is too high means that the cooking temperature is highly likely to be deviated from the selected regression model even if any one of the nonlinear regression models is selected.

The processor 180 can determine the non-calculation of the cooking temperature through other methods in addition to the above-described method. According to an embodiment, the processor 180 can control the temperature sensor 15 to detect an initial temperature of the cooking container 1 after initiating the heating mode in operation S20. This is done because the initial temperature of the cooking container 1 can imply residual heat of the cooking container 1. Thus, the processor 180 can determine that the cooking temperature is not calculated when the detected initial temperature of the cooking container 1 is higher than the predetermined reference temperature, and control the display 188 to output a notification that the cooking temperature is not calculated (e.g., if the starting temperature of the cooking container 1 is too hot, then the stored regression models may not be useful for predicting the heating of the cooking container 1 and it may be better to not attempt any predictions regarding a target temperature time). Through this, it is possible to minimize the possibility of occurrence of the error due to the residual heat of the cooking container 1.

Again, FIG. 6 will be described.

When the regression model is selected, the processor 180 can calculate at least one of the cooking temperature and the amount of time remaining until the target temperature is reached using the selected regression model (S60).

First, the processor 180 can calculate the cooking temperature using the selected regression model, and according to an embodiment, the processor 180 can further calculate the remaining time. The remaining time can refer to the remaining time until the cooking temperature reaches the target temperature or the amount of time remaining until the food item is fully cooked.

When the cooking temperature or remaining time is calculated, the processor 180 can display information related to the cooking temperature or remaining time (S70).

First, the processor 180 can control the display 188 to display the calculated cooking temperature.

According to an embodiment, the processor 180 can periodically calculate or recalculate the cooking temperature based on the selected regression model and control the display 188 to display the calculated cooking temperature. In this situation, the cooktop 10 has an advantage of being able to inform the current cooking temperature to the user in real time.

Also, the processor 180 can calculate the remaining time until reaching the target temperature based on the cooking temperature. That is, the processor 180 can calculate the remaining time required to reach the target temperature from the current cooking temperature according to the selected regression model, and control the display 188 to display the calculated remaining time.

When it is determined that the cooking temperature is not calculated, the processor 180 can control the display 188 to output a notification that the cooking temperature is not calculated. For example, the processor 180 displays a first color (e.g., green color) at one point when the cooking temperature is calculated, and displays a second color (e.g., red color) at the same point when the cooking temperature is not calculated, but is merely an example, and thus, this embodiment is not limited thereto.

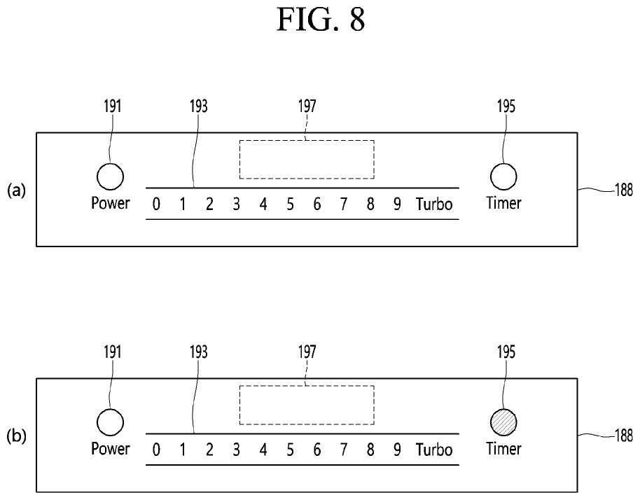

FIG. 8, including parts (a) and (b), illustrates examples of the display of the cooktop according to an embodiment of the present disclosure.

As in an example of FIG. 8, the display 188 of the cooktop 10 can be provided as a touch screen and can function as the input unit 186 together. However, this is merely an example, and the cooktop 10 can include the display 188 and the input unit 186 provided separately.

According to the example of FIG. 8, the display 188 can display at least one of power information 191, heating level information 193, timer information 195, and status information 197.

The power information 191 can indicate a power on/off state of the cooktop 10.

The heating level information 193 can indicate a level of thermal power being provided in the current heating mode. In addition, the processor 180 can adjust the heating level according to an input for selecting one of a plurality of different heating levels provided in the heating level information 193 (e.g., 0-9, and Turbo).

The timer information 195 can indicate cooking temperature related information. For example, the processor 180 can control the display 180 to output the first color (e.g., green color) to the timer information 195 when the processor 180 calculates the cooking temperature, but does not reach the target temperature, output the second color (e.g., red color) to the timer information when the cooking temperature is not calculated, and output the third color (e.g., blue color) when the target temperature has been reached, but these are merely examples and embodiments of the present disclosure are not limited thereto.

The state information 197 can indicate information about an operating state of the cooktop 10. For example, the state information 197 can display a heating level at which the cooktop 10 is currently operating at, a detected material, weight and/or thickness of the cooking container 1, and the like. In addition, the display 188 can calculate the cooking temperature and can display the remaining time in the status information 197 when it has not yet reached the target temperature.

The above-described information display methods are merely examples, and the display 188 can display various information related to the operating state of the cooktop 10 in various manners.

The cooktop 10 can further include a speaker, and an alarm or notification related to the operating state of the cooktop 10 can be output through the speaker. For example, the processor 180 can control a speaker to output an alarm when the target temperature has been reached.

As described above, since the cooktop 10 according to an embodiment of the present disclosure uses the sensed value of the temperature sensor 15 and the regression models stored in the memory 182, there is an advantage in that a separate additional sensor is not required and manufacturing costs can be reduced.

In addition, according to an embodiment of the present disclosure, since it is possible to accurately predict the cooking temperature in consideration of the material or thickness of the cooking container 1 and the amount of food in the cooking container 1, there is an advantage in being able to more accurately predict the cooking temperature or the remaining time of the cooking container 1 being heated.

In addition, according to an embodiment of the present disclosure, since the plurality of regression models are derived by testing different factors such as the type of cooking container 1, the amount of water, and the residual heat of the top plate glass 11 under various conditions, there is an advantage of being able to accurately predict the cooking temperature considering different heat transfer pattern characteristics under various heating conditions.

In the present disclosure, the processor 180 has been described as calculating the cooking temperature using the temperature of the top plate glass 11, but the current, phase, etc. of the working coil 150 can be used instead of or in addition to the temperature of the top plate glass 11. In this situation, the plurality of regression models can represent a relationship between the current or phase of the working coil 150 and the cooking temperature, and the current or phase of the working coil 150 can be obtained to calculate the cooking temperature or remaining time.

The above-disclosed subject matter is to be considered illustrative, and not restrictive, and the appended claims are intended to cover all such modifications, enhancements, and other embodiments, which fall within the true spirit and scope of the present disclosure.

Thus, the embodiments of the present disclosure are to be considered illustrative, and not restrictive, and the technical spirit of the present disclosure is not limited to the foregoing embodiments.

Therefore, the scope of the present disclosure is defined not by the detailed description of the invention but by the appended claims, and all differences within the scope will be construed as being included in the present disclosure.

1-10. (canceled)

11. A cooktop comprising:
a top plate glass configured to support placement of a cooking container;
a memory configured to store a plurality of regression models indicating a relationship between a temperature of the top plate glass and a cooking temperature;
a temperature sensor configured to sense the temperature of the top plate glass when operating in a heating mode and output a sensing value; and
a processor configured to:
select a regression model from among the plurality of regression models based on the sensing value of the temperature sensor; and
calculate the cooking temperature based on the regression model.

12. The cooktop according to claim 11, wherein the processor is further configured to:
sense the temperature of the top plate glass a plurality of times via the temperature sensor to obtain sensing values;
calculate one or more slopes based on the sensing values; and
select the regression model from among the plurality of regression models based on the one or more slopes.

13. The cooktop according to claim 12, wherein the processor is further configured to select the regression model from among the plurality of regression models based on at least one of a mean of the one or more slopes or a variance of the one or more slopes.

14. The cooktop according to claim 13, wherein the processor is further configured to:
in response to the variance being less than a preset reference value, calculate the cooking temperature based on a linear regression model; and
in response to the variance being greater than the preset reference value, calculate the cooking temperature based on a nonlinear regression model.

15. The cooktop according to claim 12, wherein the processor is further configured to:
in response to the variance being greater than or equal to a preset threshold value, output a notification indicating that the cooking temperature is not possible to be calculated.

16. The cooktop according to claim 11, further comprising a display configured to output a notification for notifying that the cooking temperature is not calculated when the variance is greater than or equal to a preset threshold value.

17. The cooktop according to claim 11, further comprising a display configured to display information,
wherein the processor is further configured to:
calculate an amount of time remaining until the cooking temperature of the cooking container reaches a target temperature; and
display the amount of time remaining via the display.

18. The cooktop according to claim 17, further comprising an input inference configured to receive the target temperature.

19. The cooktop according to claim 17, wherein the target temperature is set in advance based on a heating power level.

20. The cooktop according to claim 11, further comprising a display configured to display information,
wherein the processor is further configured to:
sense an initial temperature of the cooking container or the top plate glass after the heating mode is initiated; and
in response to the initial temperature being greater than a preset reference temperature, display a notification indicating that the cooking temperature is not possible to be calculated.

21. The cooktop according to claim 11, wherein the plurality of regression models are derived based on actual cooking temperature values measured while cooking with different types of cooking containers, an amount of water or food being cooked, and an initial temperature of the top plate glass.

22. A cooking device comprising:
a top plate glass configured to support a cooking container;
a temperature sensor configured to sense a temperature of the top plate glass; and
a controller configured to:
select a regression model from among a first type of regression model and a second type of regression model based on the temperature sensed by the temperature sensor;
calculate a cooking temperature of the cooking container based on the regression model to generate an estimated temperature of the cooking container; and
output the estimated temperature.

23. The cooking device according to claim 22, wherein the first type of regression model is a linear regression model, and
wherein the second type of regression model is a non-linear regression model.

24. The cooking device according to claim 22, wherein the controller is further configured to:
calculate at least one slope based on a plurality of temperature values sensed by the temperature sensor; and
select the regression model based on the at least one slope.

25. The cooking device according to claim 22, wherein the controller is further configured to:
calculate an amount of time remaining until the cooking temperature of the cooking container reaches a target temperature based on the regression model; and
output the amount of time remaining.

26. A method of controlling a cooking device, the method comprising:
sensing, via a temperature sensor in the cooking device, a temperature of the cooking device;
selecting a regression model, via a controller in the cooking device, from among a first type of regression model and a second type of regression model based on the temperature sensed by the temperature sensor;
calculating, via the controller, a cooking temperature of a cooking container placed on the cooking device based on the regression model to generate an estimated temperature of the cooking container; and
outputting the estimated temperature.

27. The method according to claim 26, wherein the first type of regression model is a linear regression model, and
wherein the second type of regression model is a non-linear regression model.

28. The method according to claim 26, further comprising:
calculating, via the controller, at least one slope based on a plurality of temperature values sensed by the temperature sensor; and
selecting the regression model based on the at least one slope.

29. The method according to claim 26, further comprising:
calculating, via the controller, an amount of time remaining until the cooking temperature of the cooking container reaches a target temperature based on the regression model; and
outputting, via the controller, the amount of time remaining.

30. The method according to claim 29, further comprising receiving, via a user interface of the cooking device, the target temperature from a user.
